(19) United States
(12) Patent Application Publication
(10) Pub. No.: US 2016/0261912 A1
(43) Pub. Date: Sep. 8, 2016

(54) COLLABORATIVE PLACE-SHIFTING OF VIDEO CONTENT FROM A PLURALITY OF SOURCES TO A VIDEO PRESENTATION DEVICE

(71) Applicant: ECHOSTAR TECHNOLOGIES L.L.C., Englewood, CO (US)

(72) Inventor: Max S. Gratton, Lakewood, CO (US)

(21) Appl. No.: 14/638,415

(22) Filed: Mar. 4, 2015

(51) Int. Cl. H04N 21/4402; H04N 21/647; H04N 21/442

(52) U.S. Cl. CPC H04N 21/440218; H04N 21/44245; H04N 21/44209; H04N 21/64753

(57) ABSTRACT

A video delivery system and related operating methods are presented here, including a method of providing place-shifted video content to a video presentation device. An exemplary embodiment of the method receives, from a video presentation device, a request to place-shift a particular video program. The method continues by identifying video place-shifting devices from which the particular video program is available, and by coordinating delivery of transcoded video data from the place-shifting devices to the video presentation device. The transcoded video data provided by each of the place-shifting devices conveys a different portion of the particular video program. The video presentation device processes the transcoded video data received from the place-shifting devices to reconstruct the particular video program in accordance with a native format and a specified display resolution of the video presentation device, and presents the reconstructed video content to a user.

### TECHNICAL FIELD

Embodiments of the subject matter described herein relate generally to video delivery systems and related operating methodologies. More particularly, embodiments of the subject matter relate to techniques and technologies for the collective place-shifting of video content from multiple place-shifting devices to a single end user video presentation device.

### BACKGROUND

Most television viewers now receive their video signals through a content aggregator such as a cable or satellite television provider. Digital video broadcasting (DVB) systems, such as satellite systems, are generally known. A DVB system that delivers video service to a home will usually include a video services receiver, system, or device, which is commonly known as a set-top box (STB). In the typical instance, encoded television signals are sent via a cable or wireless data link to the viewer's home, where the signals are ultimately decoded in the STB. The decoded signals can then be viewed on a television or other appropriate display as desired by the viewer.

Video place-shifting techniques enable a subscriber of a video service to view programming content on a device that is remotely located, relative to the incoming source of video. Video place-shifting can be performed by a devoted piece of hardware (i.e., equipment that is designed specifically as a place-shifting device), or by a host system, device, or piece of equipment having the desired place-shifting functionality (such as an STB or a smart television set having native place-shifting functionality integrated therein). A place-shifting device receives a source video stream, transcodes the stream for transport over a network (such as the Internet), and sends the transcoded video data to the user's remote device. Place-shifted video can be presented on a variety of user devices, such as a laptop computer, a mobile phone, a tablet computer, or the like.

The quality of place-shifted video content can be affected by various factors, some of which are dynamic in nature. For example, limited uplink bandwidth from the place-shifting device and/or limited downlink bandwidth to the end user's presentation device can adversely affect playback quality. Accordingly, it is desirable to have a place-shifting methodology that can reliably and effectively deliver place-shifted video content to a video presentation device in a way that is responsive to dynamically changing network conditions. Furthermore, other desirable features and characteristics will become apparent from the subsequent detailed description and the appended claims, taken in conjunction with the accompanying drawings and the foregoing technical field and background.

### BRIEF SUMMARY

A method of operating a video presentation device to provide place-shifted video content to a user is described herein. An exemplary embodiment of the method identifies, with the video presentation device, a particular video program that is available from a plurality of personal video source devices. The method continues by obtaining, at the video presentation device, first video data that conveys a first portion of the particular video program transcoded into a native format compatible with video playback capabilities of the video presentation device. The first video data is provided by a first personal video source device of the plurality of personal video source devices. The method also obtains, at the video presentation device, second video data that conveys a second portion of the particular video program transcoded into the native format. The second video data is provided by a second personal video source device of the plurality of personal video source devices. The video presentation device processes the obtained first and second video data to reconstruct the particular video program in accordance with the native format, resulting in reconstructed video content, and presents the reconstructed video content at the video presentation device.

A video delivery system is also described herein. An exemplary embodiment of the video delivery system includes a first personal video source device, a second personal video source device, and a video presentation device. The first personal video source device is configured to transcode a first portion of a particular video program into first video data having a designated format and a specified display resolution associated therewith, and is further configured to provide the transcoded first portion to a data communication network. The second personal video source device is configured to transcode a second portion of the particular video program into second video data having the designated format and the specified display resolution associated therewith, and is further configured to provide the transcoded second portion to the data communication network. The video presentation device is configured to communicate with the first and second personal video source devices using the data communication network. The video presentation device is also configured to obtain and process the transcoded first and second portions to reconstruct the particular video program in accordance with the designated format and the specified display resolution, resulting in reconstructed video program content. The video presentation device presents the reconstructed video program content to a user.

A method of providing place-shifted video content to a video presentation device is also described herein. An exemplary embodiment of the method receives a request to place-shift a particular video program, the request originating at the video presentation device. The method continues by identifying a plurality of video place-shifting devices from which the particular video program is available, and by coordinating delivery of transcoded video data from the plurality of video place-shifting devices to the video presentation device. The transcoded video data provided by each of the plurality of video place-shifting devices conveys a different portion of the particular video program. The video presentation device processes the transcoded video data received from the plurality of video place-shifting devices to reconstruct the particular video program in accordance with a native format and a specified display resolution of the video presentation device, and presents the reconstructed video content to a user.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified block diagram of an exemplary embodiment of a video delivery system;

FIG. 2 is a diagram that illustrates one exemplary technique for performing collaborative place-shifting of a video program from multiple video source devices to one video presentation device;

FIG. 3 is a flow chart that illustrates an exemplary embodiment of a content management process suitable for use with the video delivery system shown in FIG. 1; and

FIG. 4 is a flow chart that illustrates an exemplary embodiment of a video presentation process suitable for use with the video delivery system shown in FIG. 1.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like. The software that performs the described functionality may reside and execute at a host device, such as a video services receiver, a mobile device, or a home entertainment component, or it may be distributed for execution across a plurality of physically distinct devices, systems, or components, as appropriate for the particular embodiment.

The following description relates to a video delivery system that is suitably configured to process audio/visual content for presentation to a user. Although the following description focuses on video content (e.g., video programs, movies, recorded television shows, etc.), the subject matter may also be utilized to handle audio content conveyed in an audio stream, such as a broadcast radio program, a streaming music channel, or the like.

The exemplary embodiments described below relate to a video delivery system such as a satellite television system, a cable delivery system, an Internet-based content delivery system, or the like. The disclosed subject matter relates to a system and related methodology for delivering video data that conveys a requested video program from a plurality of different personal video source devices (which may be implemented as video place-shifting devices, video services receivers, set-top boxes, smart television sets, or the like) to the requesting video presentation device. More specifically, the disclosed methodology obtains designated portions of the requested video program from multiple video source devices operating in a cooperative manner, reconstructs the obtained video data at the viewer's presentation device, and processes the reconstructed video data for playback. The collaborative place-shifting methodology described herein can be used to reliably and effectively deliver place-shifted video content in a manner that dynamically responds to changing network conditions.

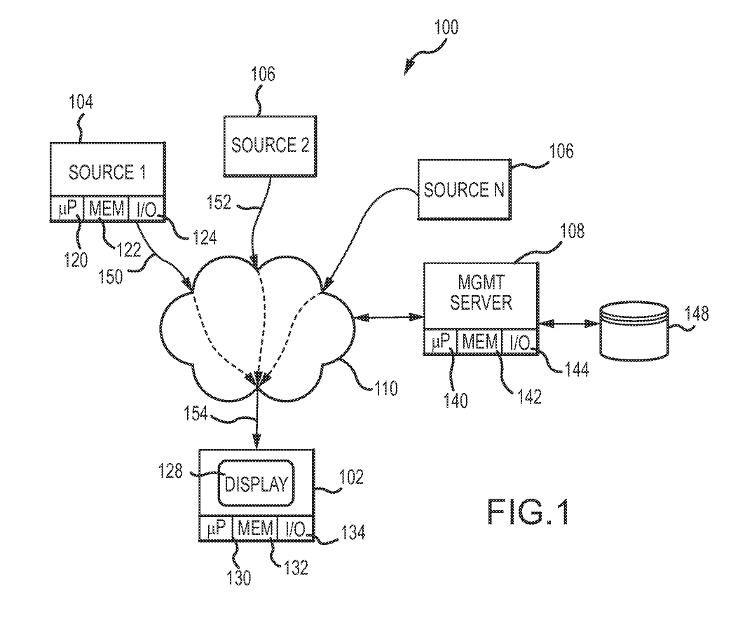

FIG. 1 is a simplified block diagram of an exemplary embodiment of a video delivery system 100. The system 100 generally includes, without limitation: a video presentation device 102 that is owned, operated, or viewed by an authorized user of the system 100; a first personal video source device 104 that is owned, operated, leased, managed, or utilized by the same authorized user (or is otherwise associated with the authorized user); any number of additional personal video source devices 106; and a management server system 108. The components of the video delivery system 100 are operatively coupled to, and communicate using, a suitably configured data communication network 110. For the sake of brevity, conventional techniques related to satellite, cable, and Internet-based communication systems, video broadcasting systems, data transmission, signaling, network control, and other functional aspects of the system components may not be described in detail herein.

In practice, the system 100 can include any number of personal video source devices; FIG. 1 depicts only three for the sake of simplicity. Moreover, the system 100 can support any number of video presentation devices, which may be owned/operated by any number of authorized end users. Furthermore, any given end user may own or operate a plurality of compatible video presentation devices. The management server system 108 will typically be operated or managed by a service provider that controls the distribution of video programming to end users. Although this example shows only one management server system 108, an embodiment of the video delivery system 100 can include a plurality of management server systems 108 that regulate the provision of video services in a cooperative or distributed manner. The particular layout and arrangement shown in FIG. 1 is not intended to limit or otherwise restrict the application or scope of the embodiments described herein.

This description assumes that each of the personal video source devices 104, 106 has legitimate and authorized access to a particular video program of interest. In a typical scenario, each of the personal video source devices 104, 106 may have access to recorded and locally stored video content, on demand video content, streaming video content, broadcast video content, or the like. The example presented here assumes that the particular video program of interest is available in a recorded format at each of the personal video source devices 104, 106. The user selects or otherwise identifies the particular video program using, for example, a suitably formatted graphical user interface of the video presentation device 102. This user action initiates a collaborative video place-shifting routine that utilizes video data stored at the different personal video source devices 104, 106. More specifically, designated portions of the selected video program are place-shifted from the personal video source devices 104, 106 in a controlled and regulated manner. The video presentation device 102 receives the video data from the personal video source devices 104, 106 and processes the received video data to reconstruct the requested video program for presentation to the user. Additional details of this methodology are described below in a more fulsome manner.

The data communication network 110 is any digital or other communications transport architecture capable of transmitting information, messages, and/or data between senders (e.g., the video source devices 104, 106) and receivers (e.g., the video presentation device 102). In various embodiments, the network 110 includes any number of public or private data connections, links, or networks supporting any number of communications protocols. The network 110 may include or utilize the Internet, for example, or any other network based upon TCP/IP or other conventional protocols. In various embodiments, the network 110 also incorporates a wireless and/or wired telephone network, such as a cellular communications network for communicating with mobile phones, personal digital assistants, and/or the like. The network 110 may also incorporate any sort of wireless or wired local area networks, such as one or more IEEE 802.3 and/or IEEE 802.11 networks.

For purposes of this example, the first personal video source device 104 can be distinguished from the other personal video source devices 106 in that the first personal video source device 104 is somehow associated with, or linked to, the user of the video presentation device 102. For example, the first personal video source device 104 might be owned, operated, leased, managed, or controlled by the user. In a typical implementation, the first personal video source device 104 is a piece of equipment or hardware that is located in the user's home, workplace, office, or the like. In contrast, the other personal video source devices 106 operating in the system 100 need not be (and usually will not be) associated or linked to the user. Rather, the other personal video source devices 106 can be associated with other users of the system 100. Other than this distinction, the different personal video source devices in the system 100 can be configured in a similar manner to perform the functions and processes described in more detail herein. Accordingly, the following description of the first personal video source device 104 also applies to the other personal video source devices 106.

The first personal video source device 104 can be realized as any device, system, hardware, or equipment that is suitably configured to support the collaborative video place-shifting techniques and technologies presented herein. In certain embodiments, therefore, the personal video source device 104 transcodes portions of a particular video program into video data having a designated format and a specified display resolution associated therewith, and provides the transcoded portions of the video program to the data communication network 110.

In accordance with various exemplary embodiments, the first personal video source device 104 can include or be implemented as any of the following, without limitation: a video services receiver or STB; a stand-alone video place-shifting device that cooperates with a video services receiver; a television set; a digital video recorder (DVR); a computer-based system; a digital disc player; a video game system; a piece of home entertainment equipment; or the like. In certain embodiments, the first personal video source device 104 is realized as a video place-shifting device, which may be a physically distinct piece of hardware that cooperates with an STB and/or a DVR for purposes of place-shifting video content, such as the SLINGBOX® 500, manufactured by Sling Media, Inc. of Foster City, Calif. In alternative embodiments, the first personal video source device 104 is realized as an STB having native video place-shifting functionality, such as the HOPPER® with SLING®, manufactured by EchoStar Technologies L.L.C. of Englewood, Colo.

The first personal video source device 104 can be considered to be a computer-based or a processor-based electronic device. In this regard, the first personal video source device 104 includes a conventional processor 120, an appropriate amount of memory 122, and input/output features 124 (e.g., user and network interfaces), in additional to any other hardware, software and/or firmware components that are commonly associated with conventional consumer electronics or computing devices. The first personal video source device 104 typically incorporates a software or firmware program that resides in the memory 122, wherein the program instructions are executable by the processor 120 to perform the various functions described herein.

In some implementations, the first personal video source device 104 includes or communicates with a storage device such as a hard disk drive, the memory 122, or the like. The storage device may be used to buffer and/or store recorded video content for later viewing. In this regard, the first personal video source device 104 may include native DVR functionality, or it can cooperate with a DVR device or system to obtain recorded or buffered video content for place-shifting in the manner described herein.

A video place-shifting device is any component, hardware, software logic, etc., or any combination thereof, which is capable of transmitting a packetized stream of media content over the network 110. In various embodiments, a place-shifting device incorporates suitable encoder and/or transcoder (collectively “encoder”) logic to convert audio/video or other media content (e.g., a recorded video program or portions thereof) into a packetized format that can be transmitted over the network 110. The original video data may be received in any format, and may be received from any internal or external media source such as any sort of broadcast source, a cable or satellite television programming source, a “video-on-demand” or similar source, a DVD or other removable media, a video camera, and/or the like. In some operating scenarios, a video stream received and processed by the place-shifting device is a recorded video stream, which may be provided by a media source, by a DVR module, by an STB coupled to the place-shifting device, or the like. In this context, the recorded video stream could be realized as a locally recorded file, or it could be realized as an on-demand video stream. In some operating scenarios, a video stream received and processed by the place-shifting device is a non-recorded broadcast video stream, which is currently being delivered by a video services system. The place-shifting device may transcode the original video data to create transcoded video data in any manner. In various embodiments, the place-shifting device contains a transmit buffer that temporarily stores encoded data prior to transmission on the network 110.

The video presentation device 102 is any device, component, module, hardware, software, etc., or any combination thereof, which is capable of receiving video data from the personal video source devices 104, 106. For this particular example, the video presentation device 102 communicates with the personal video source devices 104, 106 using the data communication network 110. The video presentation device 102 is suitably configured to obtain and process transcoded portions of a video program (received from different personal video source devices), and to reconstruct the video program in accordance with a designated format and display resolution that are compatible with the native capabilities of the video presentation device 102. The reconstructed video content can then be rendered and presented to the user of the video presentation device 102.

In practice, the video presentation device 102 may include a display 128, a conventional processor 130, memory 132, and input/output features 134 (as generally described above for the first personal video source device 104). In various embodiments, the video presentation device 102 is personal computer (e.g., a laptop or similarly portable computer, although desktop-type computers could also be used), a tablet computing device, a mobile phone, a personal digital assistant, a personal media player, or the like. In many embodiments, the video presentation device 102 is a general purpose computing device that includes a media player application in software or firmware that is capable of securely connecting to the personal video source devices 104, 106, and is capable of receiving and presenting media content to the user of the video presentation device 102 as appropriate. In other embodiments, however, the video presentation device 102 is a standalone or other separate hardware device capable of receiving an encoded video stream via any portion of the network 110 and decoding the encoded video stream to provide an output signal that is presented on the display 128.

The management server system 108 may be provided to facilitate centralized control and management of video place-shifting. In this regard, the management server system 108 can be implemented as any device, component, module, hardware, software, etc., or any combination thereof, which is capable of performing the various management, control, and regulation procedures described herein. Accordingly, the management server system 108 may include a conventional processor 140, memory 142, and input/output features 144 (as generally described above for the first personal video source device 104).

The management server system 108 is coupled to the network 110 for data communication with the personal video source devices 104, 106 and for data communication with the video presentation device 102 as needed. The management server system 108 is suitably configured to assist devices in locating each other, maintain security, coordinate the place-shifting of video content, and/or perform any other features as desired. For example, the management server system 108 can be implemented to regulate the operation of the various personal video source devices 104, 106 in response to a request for a particular video program that has been issued by the video presentation device 102. Such requests can be generated when the end user selects or otherwise identifies a video program that is available to be place-shifted. As another example, the management server system 108 can be employed to analyze or diagnose the various network links utilized by the personal video source devices 104, 106 and the video presentation device 102. The management server system 108 can use the results of network diagnostics to select which personal video source devices to use for place-shifting of a particular video program, to determine which portions of the video program will be place-shifted by each personal video source device, etc.

In various embodiments, the management server system 108 can be used to identify and locate the personal video source devices 104, 106 as needed, and to communicate with the video presentation device 102 so that the place-shifted video content can be properly delivered to the video presentation device 102. To that end, the management server system 108 may be implemented as a computerized service that facilitates data connections between the components operating within the system 100. Moreover, the management server system 108 typically operates in conjunction with a database 148 that maintains database objects that associates customers or other users with their particular personal video source devices 104, 106. The database 148 can also maintain database objects that include information identifying the personal video source devices 104, 106, information identifying the video program content available from the personal video source devices 104, 106, metadata associated with the available video program content, and the like. Such database objects can be updated as needed to keep the database 148 current, and to allow the management server system 108 to determine how best to accommodate remote place-shifting requests for video programs stored in association with the various personal video source devices.

As mentioned above, the video presentation device 102 receives different portions of a place-shifted video program from a plurality of different place-shifting devices (e.g., different personal video source devices 104, 106). The system 100 can be designed to segment a particular video program in accordance with any appropriate scheme or methodology. For example, it may be desirable to divide the video program into time-based segments, e.g., one-second segments, five-second segments, or the like. As another example, the system 100 may separate the video program in accordance with a video frame count or a packet count. Another example assumes that the video program of interest is expressed or represented by a group of pictures (GOP) structure having a plurality of GOPs. In accordance with standard nomenclature, the GOP structure specifies the manner in which picture frames are arranged in an encoded video stream. As is well understood, a GOP is typically defined by an I-frame followed by a series of other frame types (such as P-frames and B-frames). Conventional GOP structures and related technologies are well known. Accordingly, concepts related to GOPs will not be described in detail here.

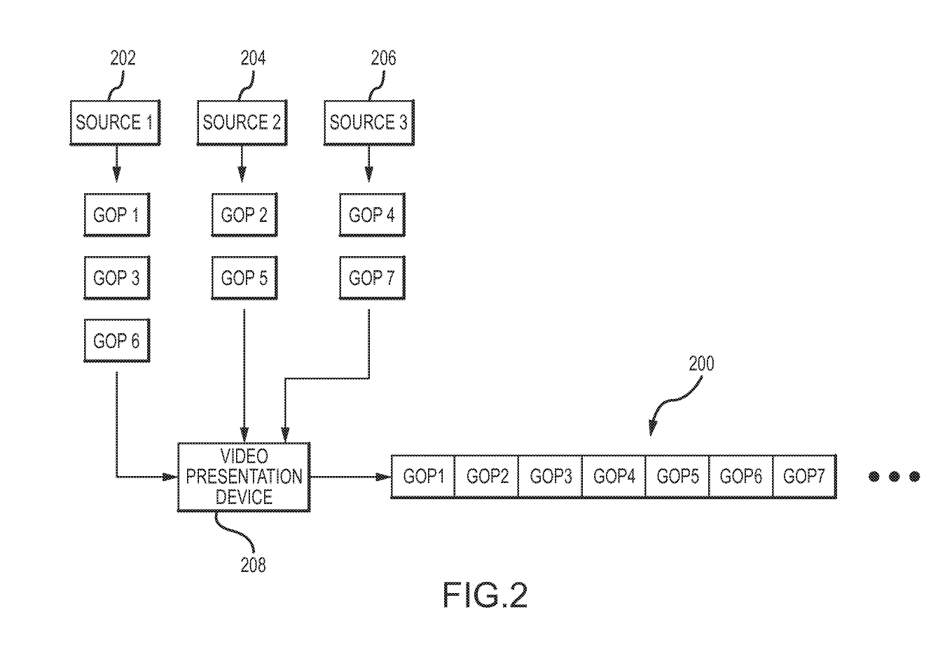

FIG. 2 is a diagram that illustrates one exemplary technique for performing collaborative place-shifting of a video program 200 from multiple video source devices 202, 204, 206 to one video presentation device 208. The video program 200 is represented by a number of GOPs in sequence. For simplicity, FIG. 2 only depicts the first seven GOPs of the video program 200. Any suitable algorithm or methodology can be utilized to determine which portion of the video program 200 will be place-shifted by the video source device 202, which portion of the video program 200 will be place-shifted by the video source device 204, and which portion of the video program 200 will be place-shifted by the video source device 206. This example assumes that any given GOP is provided by only one of the available video source devices 202, 204, 206. In an alternative embodiment, redundant delivery of GOPs can be supported if so desired.

The illustrated example assumes that the video source device 202 is responsible for place-shifting GOP 1, GOP 3, and GOP 6 (not necessarily in that order). A different video source device 204 is responsible for place-shifting GOP 2 and GOP 5 (not necessarily in that order). Yet another video source device 206 is responsible for place-shifting GOP 4 and GOP 7 (not necessarily in that order). The video data may be received from the video source devices 202, 204, 206 at the same bitrate or at two or more different bitrates. The number of GOPs processed and place-shifted by each video source device 202 can be determined by the management server system 108, by the video presentation device 208, by any combination of one or more of the video source devices, or any combination thereof. The decision criteria used to determine which portion of the video program is delivered by which video source device may vary from one embodiment to another. In another embodiments, each of the video source devices 202, 204, 206 may distribute portions of the GOP, for example video source device 202 transmits I-frames, while video source devices 204, 206 transmit B or P frames.

In accordance with some embodiments, the system is controlled such that the video source device 202 (which is associated with the user or owner of the video presentation device 208) provides the majority of the place-shifted video content. This requirement may be desirable to satisfy certain legal or regulatory concerns regarding the personal use of recorded content. In certain embodiments, the partitioning of the original video program into different segments or GOPs is based on current performance metrics, network operating conditions, quality of service (QoS) measurements, or the like. Referring again to FIG. 1, for example, a performance metric (such as available bandwidth) for a network upload link 152 utilized by the first personal video source device 104 can influence whether or not other personal video source devices will be needed to accomplish the desired place-shifting of the video program. In this regard, if the available bandwidth, QoS, error rate, or reliability of the network upload link 152 is suspect or does not satisfy certain performance criteria, then system 100 can select additional video source devices for purposes of sharing the place-shifting load.

With continued reference to FIG. 1, if a network upload link 152 utilized by the personal video source device 106 can accommodate a high data rate, then more place-shifted video content can be delivered by that video source device 106. In this regard, the amount of video data place-shifted by each personal video source device 104, 106 can be dictated by the available bandwidth, maximum data rate, or other performance metrics associated with the corresponding network upload links. Moreover, the system 100 may contemplate a network download link 154 utilized by the video presentation device to accommodate place-shifted video data. For example, if the network download link 154 is of limited bandwidth, then the system 100 can regulate and control the collaborative place-shifting methodology in an appropriate manner that does not overtax the network download link 154.

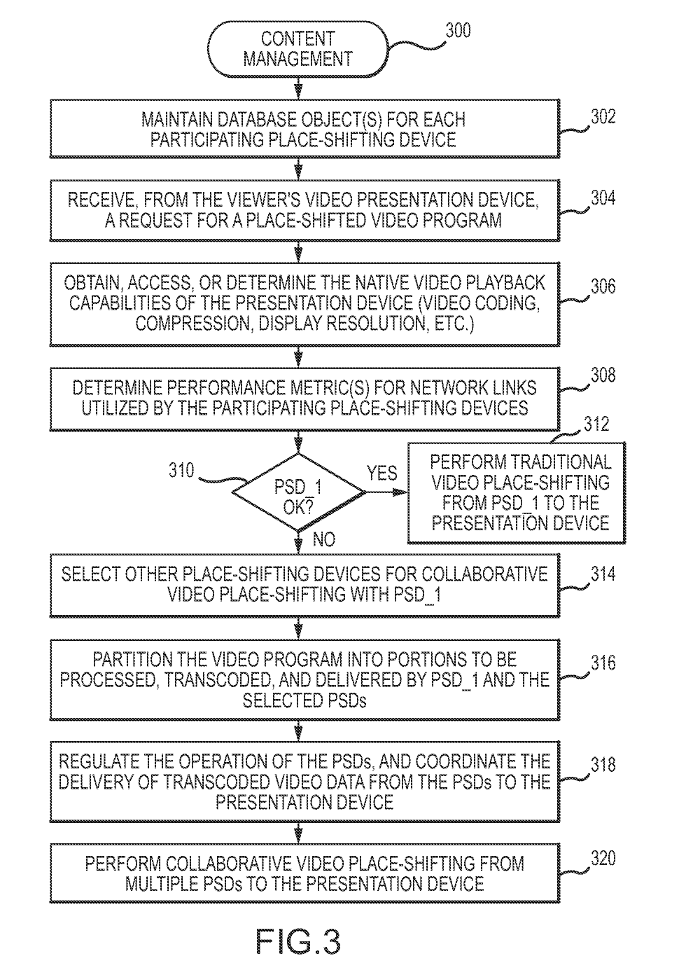

One or more components of the system 100 can influence, determine, or otherwise regulate the operation of the collaborative video place-shifting methodology in a way that responds to dynamically changing conditions of the network 110 and/or dynamically changing status of the components themselves. In this regard, FIG. 3 is a flow chart that illustrates an exemplary embodiment of a content management process 300 suitable for use with the video delivery system 100. The various tasks described in connection with an illustrated process may be performed by software, hardware, firmware, or any combination thereof. For illustrative purposes, the following description may refer to elements mentioned above in connection with FIGS. 1 and 2. In practice, portions of a process may be performed by different elements of the described system 100, e.g., a personal video source device, the video presentation device, the management server system, or the like. It should be appreciated that a process described herein may include any number of additional or alternative tasks, the tasks shown in the figures need not be performed in the illustrated order, and that a described process may be incorporated into a more comprehensive procedure or process having additional functionality not described in detail herein. Moreover, one or more of the tasks shown for an illustrated process could be omitted as long as the intended overall functionality remains intact.

The process 300 creates and maintains at least one database object for each participating/available place-shifting device in the system (task 302). The database objects may be maintained at the management server system, at the video presentation device, and/or at one or more of the place-shifting devices. The database entry for each place-shifting device may include information that identifies that particular place-shifting device, e.g., a MAC address, an IP address, or a unique serial number. The database entry for each place-shifting device also includes information that identifies the video program content that is currently available from that particular place-shifting device. In this regard, task 302 can maintain and update a “playlist” of video content accessible at each place-shifting device. The database entry may also include metadata associated with the available video content. Moreover, the database entry for each place-shifting device may include diagnostic information that indicates or describes certain network or system operating parameters, which may be subsequently utilized by the process 300. For example, the database entry may include the results of network diagnostics to be used for place-shifting device selection, video program segmentation, and the like.

The process 300 receives a request for a place-shifted video program (task 304). The request may originate at the video presentation device, or at any device or system operated by the viewer. The request may be received at the management server system and/or at one or more of the place-shifting devices. Task 304 may be responsive to user manipulation of a graphical user interface displayed by the video presentation device, wherein the user interface allows the user to browse and select video content that is available at one or more of the place-shifting devices. This example assumes that the requested video program is available at the place-shifting device that is owned or operated by the user.

The process 300 may obtain, access, or determine the native video playback capabilities of the video presentation device (task 306). Task 306 may be performed by the management server system, by the video presentation device as a self-reporting function, and/or by one or more of the video place-shifting devices. The process 300 may obtain the particular video coding scheme, video compression scheme, compatible video formats, display resolution, display size, and/or other video playback parameters that are specific to the video presentation device. The parameters obtained during task 306 can be used to control transcoding (if any) performed by the place-shifting devices.

The process 300 may continue by determining certain performance metrics for the network upload links utilized by the participating place-shifting devices (task 308). Task 308 may also determine performance metrics for the network download link utilized by the video presentation device. Task 308 can be performed by the management server system, by the video presentation device, and/or by one or more of the place-shifting devices. As mentioned previously, the performance metrics may be indicative of: available bandwidth of the upload links; data rate; data throughput; error rate; QoS; or the like.

The illustrated embodiment of the process 300 checks whether the first place-shifting device (i.e., the place-shifting device that is owned or operated by the user of the video presentation device) can handle the place-shifting of the requested video program by itself. This check may be performed by the management server system, the video presentation device, or the first place-shifting device as a self-check. If the first place-shifting device can handle the request by itself (the “Yes” branch of query task 310), then the process 300 continues by performing traditional video place-shifting from the first place-shifting device to the video presentation device (task 312). If not, (the “No” branch of query task 310), then the process 300 identifies and selects other place-shifting devices to be used for collaborative video place-shifting with the first place-shifting device (task 314). Task 314 identifies other place-shifting devices from which the requested video program is also available. In practice, task 314 can be performed by the management server system or the first place-shifting device. In some implementations, task 314 can be performed by the video presentation device.

Task 312 can be performed when the first place-shifting device can handle the delivery of the video data using the currently available bandwidth of the upload link, without resulting in quality issues or video degradation at the presentation device. In contrast, task 314 can be performed when the performance metrics determined at task 308 do not satisfy certain threshold criteria. For example, one or more additional place-shifting devices can be identified and selected when the available bandwidth of the upload link from the first video place-shifting device is less than a designated minimum bandwidth that is otherwise required to accommodate a transcoded version of the requested video program. Moreover, the selection of the additional place-shifting devices (task 314) may be based on a performance metric of the network download link utilized by the video presentation device. In this regard, if the network download link is rather limited, then task 314 may select only one additional place-shifting device, and the bandwidth of the upload links from the place-shifting devices need not be closely scrutinized. On the other hand, if the network download link is wide open to accommodate a very high data rate, then task 314 may select multiple place-shifting devices in an attempt to take advantage of the high potential incoming data rate.

The process 300 also partitions, divides, or segments the requested video program into portions to be processed, transcoded (if needed or desired), and delivered by the first video place-shifting device and by the additional place-shifting devices (task 316). Task 316 will typically be performed by the management server system or by one or more of the place-shifting devices. Although not always required, this example assumes that task 316 assigns GOPs to each of the place-shifting devices, as explained above with reference to FIG. 2. Thus, the result of task 316 is an assignment of GOPs to their respective place-shifting devices. In certain embodiments, task 316 is governed or influenced by the performance metrics obtained at task 308. Accordingly, designating which portions of the video program will be handled by each place-shifting device can be based on the various performance metrics. For example, a place-shifting device having an upload link with a large amount of available bandwidth can be assigned more GOPs to deliver, relative to another place-shifting device having an upload link with less available bandwidth.

The process 300 may continue by regulating the operation of the place-shifting devices, and by coordinating the delivery of transcoded video data from the place-shifting devices to the video presentation device (task 318). The place-shifting devices operate in accordance with certain instructions and commands, which may originate at the management server system or at the first place-shifting device. In some embodiments, the place-shifting devices operate in accordance with instructions and commands issued by the video presentation device. Task 318 results in the place-shifting of different portions of the requested video program from different place-shifting devices. The place-shifting devices may perform transcoding, reformatting, resizing, and/or other video data manipulation if needed for compatibility with the native video processing and rendering capabilities of the video presentation device. For example, if the original video program has a full high definition resolution of 1080p, but the video presentation device is a mobile device having lower high definition resolution or only standard resolution capabilities, then the place-shifting devices can perform transcoding before providing the transcoded video data to the video presentation device. Transcoding may also occur based on bandwidth limitations of the various network links.

The process 300 continues by performing collaborative video place-shifting from multiple place-shifting devices to the video presentation device (task 320). Task 320 may be performed by the place-shifting devices (as video data senders) and the video presentation device (as the video data receiver).

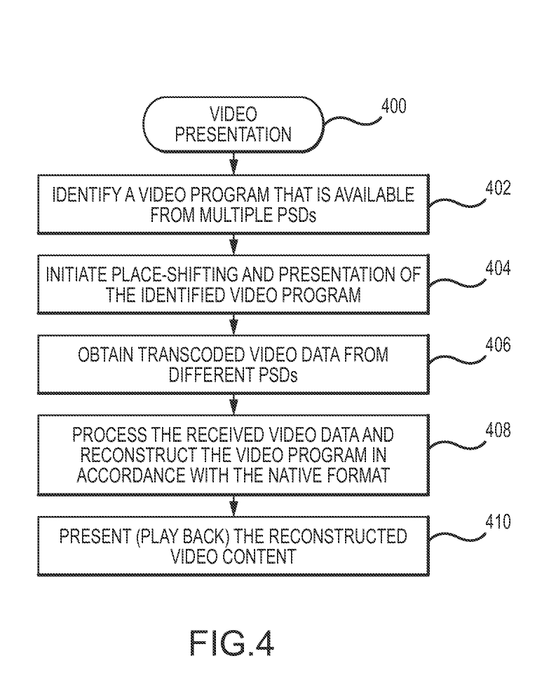

The process 300 primarily includes management and configuration tasks that need not be performed by the end user client device, i.e., the video presentation device. The above description of the process 300 concentrates on certain functions and routines that control the manner in which the original video content is divided for coordinated place-shifting by multiple place-shifting devices. FIG. 4, on the other hand, is a flow chart that illustrates an exemplary embodiment of a video presentation process 400 that can be performed by a video presentation device.

The process 400 identifies a video program that is available from multiple place-shifting devices (task 402). As mentioned above, the user of a remote video presentation device can manipulate a graphical user interface or other selection mechanism to choose a particular video program from a list of available content. In certain embodiments, the user can select any video program that is already recorded and stored at his or her primary premises, e.g., a recorded movie or a show that is stored in association with a DVR feature, a STB, or a place-shifting device located at the user's home. In such embodiments, the system may check that the user indeed has recorded the requested content before allowing collaborative place-shifting. In other embodiments, the system can allow collaborative place-shifting regardless of whether or not the user has already recorded the requested video content. In response to the selection of the particular video program, the process 400 initiates transcoding, place-shifting, and presentation of the identified video program (task 404). It should be appreciated that some of the system-wide processing described above for the process 300 can be initiated by task 404.

This example assumes that the video presentation device obtains transcoded video data from a plurality of different place-shifting devices (task 406). Thus, the video presentation device receives different portions of the requested video program from different place-shifting devices. Each place-shifting device can be operated such that it transcodes the appropriate video data into a native format and display resolution that is compatible with the video playback capabilities of the video presentation device. As mentioned previously, the video data received by the video presentation device may correspond to GOPs transcoded and provided by the different participating video place-shifting devices. Video data can be communicated to the video presentation device at different bitrates, depending on the current network operating conditions and bandwidth available on the various data communication links. For example, a first video place-shifting device may provide transcoded video data at a relatively high bitrate that can be accommodated by the network upload link that connects the first video place-shifting device to the data communication network, while a second video place-shifting device may provide its transcoded video data at a relatively low bitrate (that is different than the bitrates used by the first video place-shifting device) due to practical bandwidth limitations of its network upload link.

The system coordinates delivery of transcoded video data from multiple video place-shifting devices to the video presentation device, such that the transcoded video data provided by each of the place-shifting devices conveys a different portion of the requested video program. The user's presentation device processes the received video data to reconstruct the requested video program in accordance with the native format and display resolution of the presentation device (task 408). The reconstructed video content is then rendered and presented to the user (task 410), using the native display and audio features of the video presentation device. In certain embodiments, the place-shifted video content can include timestamp information, synchronization data, timing markers, or other information that can be utilized by the video presentation device for purposes of accurately reconstructing the video program. The synchronization information can be provided by the place-shifting devices or it may be provided as metadata from the original source of the recorded video content. The synchronization information enables the video presentation device to piece the original video program together using a consistent time frame, regardless of where the place-shifted segments originate (e.g., different time zones).

A video delivery system configured as described herein can be utilized to control multiple video source devices in a way that results in collaborative place-shifting of video content to a requesting video presentation device. In one exemplary scenario, the user's presentation device connects to a first video source that is associated with the user (e.g., the user's home STB or DVR device) and requests place-shifting of a particular video program. Although not always required, the system can mandate that at least some of (or the majority of) the place-shifted video content be served from the user's video source, as an authentication or confirmation mechanism to ensure that the user has a legitimate copy of, or access to, the requested video program. The presentation device, a management server system, or the first video source can determine whether the network upload link from the first video source has insufficient bandwidth or is otherwise unable to place-shift the requested video program in a manner that satisfies certain minimum quality standards. If so, the presentation device or the first video source device contacts the management server system, which identifies at least one additional source device that can provide the requested video program. The management service may identify different additional source devices based on various criteria, such as reliability of the network link, geographic proximity, or status of the device (e.g., a particular source device is not in use). The first video source device and/or the management server system coordinates transcoding (if needed) and delivery of place-shifted video data by the participating video source devices. In this way, the presentation device can contact all of the participating video source devices to obtain place-shifted video content, process the received video data, and reconstruct the video program.

The specific way in which a requested video program is divided into individual portions or segments for purposes of collaborative place-shifting may vary, depending upon the specific embodiment or system configuration. As mentioned above, the video program can be separated by GOPs such that different GOPs are assigned to different place-shifting devices. Alternatively, the video program can be divided by frames, time periods, packets, or in accordance with other schemes. For example, one or more source devices may deliver video data, while other source devices may deliver audio data. Moreover, the system can be suitably configured to coordinate the delivery of the place-shifted video content based on the current network conditions, such as available bandwidth of the various upload links and the available bandwidth of the download link used by the presentation device. For example, the system can coordinate the various place-shifting devices such that more packets of place-shifted video data are provided by source devices having higher available upload bandwidth, while source devices having less available bandwidth handle less of the place-shifted video data.

In certain embodiments, the place-shifted video content is transcoded for compatibility with the destination presentation device. Transcoding may also be performed as needed to accommodate upload links having limited bandwidth. For example, if sufficient network bandwidth is available to all of the system components, then transcoding may not be necessary. If, however, one of the network upload links has limited bandwidth, then the place-shifted video content delivered over that upload link can be transcoded to a lower bitrate. If more place-shifting devices are available, then the system can utilize some or all of those devices for purposes of bandwidth allocation, thus reducing the loading experienced by any one of the participating place-shifting devices.

The number of video source devices may also be influenced by changing bandwidth of individual links or use of the video source devices. For example, if an additional video source device was previously idle, by another user subsequently connected to such device for a place-shifting session, then the management server may instruct the presentation device to replace communications with a different source device. Likewise, if bandwidth along various communication links increases or decreases, then the management server or presentation device may determine whether to increase or decrease the number of additional video source devices utilized for a particular place-shifting session.

As noted above, the regulation, control, coordination, and management of tasks related to the initiation and performance of collaborative place-shifting can be executed by one or more of the components in the system. Certain embodiments employ a centralized management server system, but other implementations may instead utilize the processing capabilities of the place-shifting devices and the user's presentation device. The management and coordination functions (regardless of where or how they might be implemented) enable the system to dynamically contemplate the current network conditions to determine how best to divide the video content for purposes of place-shifting by multiple devices, how best to select the participating place-shifting devices, to determine a preferred transcoding scheme, and the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method of operating a video presentation device to provide place-shifted video content to a user, the method comprising:
identifying, with the video presentation device, a particular video program that is available in a recorded format from a plurality of personal video source devices including a first personal video source device that is associated with the user;
obtaining, at the video presentation device, first video data that conveys a first portion of the particular video program transcoded into a native format compatible with video playback capabilities of the video presentation device, the first video data provided by the first personal video source device of the plurality of personal video source devices, the first portion of the particular video program representing a majority of the particular video program;
obtaining, at the video presentation device, second video data that conveys a second portion of the particular video program transcoded into the native format, the second video data provided by a second personal video source device of the plurality of personal video source devices;
processing, by the video presentation device, the obtained first and second video data to reconstruct the particular video program in accordance with the native format, resulting in reconstructed video content; and
presenting the reconstructed video content at the video presentation device.

2. The method of claim 1, further comprising:
determining a performance metric for a network upload link utilized by the first personal video source device; and
selecting a particular one of the plurality of personal video source devices for use as the second personal video source device, based on the determined performance metric.

3. The method of claim 2, wherein:
the performance metric is indicative of available bandwidth of the network upload link utilized by the first personal video source device; and
the selecting is initiated when the available bandwidth is less than a minimum bandwidth required to accommodate a transcoded version of the particular video program.

4. The method of claim 1, further comprising:
determining a first performance metric for a first network upload link utilized by the first personal video source device;
determining a second performance metric for a second network upload link utilized by the second personal video source device; and
designating the first and second portions of the particular video program, based on the determined first and second performance metrics.

5. The method of claim 1, further comprising:
maintaining a database object that includes information identifying each of the plurality of personal video source devices, information identifying recorded video program content available from each of the plurality of personal video source devices, and metadata associated with the recorded video program content available from each of the plurality of personal video source devices.

6. The method of claim 1, further comprising:
determining a performance metric for a network download link utilized by the video presentation device; and
selecting the first personal video source device and the second personal video source device, based on the determined performance metric.

7. The method of claim 1, wherein:
the particular video program is represented by a group of pictures (GOP) structure having plurality of GOPs;
the first video data conveys a first subset of the plurality of GOPs; and
the second video data conveys a second subset of the plurality of GOPs.

8. The method of claim 1, wherein:
the video presentation device obtains the first video data at a first bitrate; and
the video presentation device obtains the second video data at a second bitrate that is different than the first bitrate.

9. A video delivery system comprising:
a first personal video source device associated with a user, the first personal video source device storing a first recorded copy of a particular video program, and configured to transcode a first portion of the first recorded copy of the particular video program into first video data having a designated format and a specified display resolution associated therewith, and further configured to provide the transcoded first portion to a data communication network the first portion of the first recorded copy of the particular video program representing a majority of the particular recorded video program;
a second personal video source device storing a second recorded copy of the particular video program, and configured to transcode a second portion of the second recorded copy of the particular video program into second video data having the designated format and the specified display resolution associated therewith, and further configured to provide the transcoded second portion to the data communication network; and
a video presentation device associated with the user, and configured to communicate with the first and second personal video source devices using the data communication network, the video presentation device configured to obtain and process the transcoded first and second portions to reconstruct the particular video program in accordance with the designated format and the specified display resolution, resulting in reconstructed video program content, and the video presentation device further configured to present the reconstructed video program content to the user.

10. The system of claim 9, wherein:
the first personal video source device comprises a first video place-shifting device; and
the second personal video source device comprises a second video place-shifting device.

11. The system of claim 10, wherein:
the first video place-shifting device is realized as a first video services receiver device; and
the second video place-shifting device is realized as a second video services receiver device.

12. The system of claim 9, further comprising a management server system in data communication with the first personal video source device, the second personal video source device, and the video presentation device, the management server system configured to regulate operation of the first and second personal video source devices in response to a request for the particular video program, the request issued by the video presentation device.

13. The system of claim 12, wherein the management server system determines a performance metric for a network upload link utilized by the first personal video source device, and selects the second personal video source device from a plurality of available personal video source devices, based on the determined performance metric.

14. The system of claim 12, wherein the management server system determines a first performance metric for a first network upload link utilized by the first personal video source device, determines a second performance metric for a second network upload link utilized by the second personal video source device, and designates the first and second portions of the particular video program, based on the determined first and second performance metrics.

15. The system of claim 12, wherein the management server system maintains a database object that includes information identifying the first and second personal video source devices, information identifying recorded video program content available from the first and second personal video source devices, and metadata associated with the recorded video program content available from the first and second personal video source devices.

16. The system of claim 9, wherein:
the particular video program is represented by a group of pictures (GOP) structure having plurality of GOPs;
the first video data conveys a first subset of the plurality of GOPs; and
the second video data conveys a second subset of the plurality of GOPs.

17. The system of claim 9, wherein:
the video presentation device obtains the first video data at a first bitrate; and
the video presentation device obtains the second video data at a second bitrate that is different than the first bitrate.

18. A method of providing place-shifted video content to a video presentation device of a user, the method comprising:
receiving a request to place-shift a recorded video program, the request originating at the video presentation device;
identifying a plurality of video place-shifting devices from which the recorded video program is available, the plurality of video place-shifting devices including a first video place-shifting device that is associated with the user;
coordinating delivery of transcoded video data from the plurality of video place-shifting devices to the video presentation device, wherein the transcoded video data provided by each of the plurality of video place-shifting devices conveys a different portion of the recorded video program, and wherein the transcoded video data provided by the first video place-shifting device represents a majority of the recorded video program;
processing, by the video presentation device, the transcoded video data received from the plurality of video place-shifting devices to reconstruct the recorded video program in accordance with a native format and a specified display resolution of the video presentation device; and
presenting the reconstructed video content at the video presentation device.

19. The method of claim 18, further comprising:
determining performance metrics for upload links utilized by the plurality of video place-shifting devices, wherein the coordinating step is based on the determined performance metrics.

20. The method of claim 18, wherein:
the recorded video program is represented by a group of pictures (GOP) structure having plurality of GOPs; and
the coordinating step identifies, for each of the plurality of video place-shifting devices, a respective subset of the plurality of GOPs for transcoding and delivery to the video presentation device.
